(19) United States
(12) Patent Application Publication
(10) Pub. No.: US 2015/0369964 A1
(43) Pub. Date: Dec. 24, 2015

(54) METHOD FOR PRODUCING POLARIZING FILM

(71) Applicant: NITTO DENKO CORPORATION, Ibaraki-shi, Osaka (JP)

(72) Inventors: Tomohiro Mori, Ibaraki-shi (JP); Takashi Kamijo, Ibaraki-shi (JP); Minoru Miyatake, Ibaraki-shi (JP)

(73) Assignee: NITTO DENKO CORPORATION, Ibaraki-shi, Osaka (JP)

(21) Appl. No.: 14/767,345

(22) PCT Filed: Feb. 6, 2014
(86) PCT No.: PCT/JP2014/052732

§ 371 Date: Aug. 12, 2015

(30) Foreign Application Priority Data
Feb. 15, 2013 (JP) 2013-027505

(51) Int. Cl. G02B 1/10; G02B 5/30

(52) U.S. Cl. CPC G02B 1/10; G02B 5/3033

(57) ABSTRACT

Provided is a manufacturing method for a polarizing film having excellent manufacturing efficiency while maintaining optical characteristics. A manufacturing method for a polarizing film of the present invention includes in this order, the steps of: stretching a resin substrate in a first direction; heating the resin substrate; forming a polyvinyl alcohol-based resin layer on the resin substrate, to thereby produce a laminate; and stretching the laminate in a second direction.

### TECHNICAL FIELD

The present invention relates to a method of manufacturing a polarizing film.

### BACKGROUND ART

Polarizing films are placed on both sides of the liquid crystal cell of a liquid crystal display apparatus as a typical image display apparatus, the placement being attributable to the image-forming mode of the apparatus. For example, the following method has been proposed as a method of manufacturing the polarizing film (for example, Patent Literature 1). A laminate having a resin substrate and a polyvinyl alcohol (PVA)-based resin layer is stretched, and is then subjected to a dyeing treatment so that the polarizing film may be obtained on the resin substrate. According to such method, a polarizing film having a small thickness is obtained. Accordingly, the method has been attracting attention because of its potential to contribute to the thinning of an image display apparatus in recent years.

Incidentally, it is generally known that, in manufacture of the polarizing film, the film shrinks in a direction approximately perpendicular to its stretching direction, and the shrinkage may improve optical characteristics. However, when the shrinkage ratio is too high, manufacturing efficiency is insufficient, which involves, for example, a problem in that a polarizing film having a desired size (manufacturing width) cannot be obtained.

### CITATION LIST

### Patent Literature

[PTL 1] JP 2000-338329 A

### SUMMARY OF INVENTION

### Technical Problem

The present invention has been made to solve the problem, and a primary object of the present invention is to provide a manufacturing method for a polarizing film having excellent manufacturing efficiency while maintaining optical characteristics.

### Solution to Problem

According to one aspect of the present invention, a manufacturing method for a polarizing film is provided. The manufacturing method includes in this order, the steps of: stretching a resin substrate in a first direction; heating the resin substrate; forming a polyvinyl alcohol-based resin layer on the resin substrate, to thereby produce a laminate; and stretching the laminate in a second direction.

In one embodiment of the invention, the stretching in the first direction is performed at a temperature of from 70° C. to 150° C.

In one embodiment of the invention, the heating is performed at a temperature of from 70° C. to 150° C.

In one embodiment of the invention, the resin substrate is formed from a polyethylene terephthalate-based resin.

In one embodiment of the invention, the resin substrate after the heating has a Δn of 0.0016 or less.

According to another aspect of the present invention, a polarizing film is provided. The polarizing film is obtained by the manufacturing method.

According to still another aspect of the present invention, an optical laminate is provided. The optical laminate includes the polarizing film.

According to still another aspect of the present invention, a laminate is provided. The laminate includes a resin substrate that is formed from a polyethylene terephthalate-based resin and has a Δn of 0.0016 or less, and a polyvinyl alcohol-based resin layer formed on the resin substrate.

### Advantageous Effects of Invention

According to the present invention, it is possible to manufacture the polarizing film having extremely excellent optical characteristics efficiently by stretching and then heating the resin substrate. Specifically, when the laminate is produced by forming the PVA-based resin layer while reducing a residual stress generated by stretching the resin substrate in the first direction, the ratio of shrinkage in the first direction can be decreased during stretching of the laminate in the second direction. As a result, manufacturing efficiency can be improved.

### BRIEF DESCRIPTION OF DRAWINGS

FIG. 1 is a schematic view for illustrating one example of a first stretching step and a heating step.

FIG. 2 is a schematic sectional view of a laminate according to a preferred embodiment of the present invention.

FIG. 3(a) and FIG. 3(b) are each a schematic sectional view of an optical film laminate using a polarizing film of the present invention.

FIG. 4(a) and FIG. 4(b) are each a schematic sectional view of an optically functional film laminate using the polarizing film of the present invention.

### DESCRIPTION OF EMBODIMENTS

Hereinafter, preferred embodiments of the present invention are described. However, the present invention is not limited to these embodiments.

A. Manufacturing Method for Polarizing Film

A manufacturing method for a polarizing film of the present invention includes, in this order, the steps of: stretching a resin substrate in a first direction (first stretching step); heating the resin substrate (heating step); forming a polyvinyl alcohol (PVA)-based resin layer on the resin substrate, to thereby produce a laminate (laminate-producing step); and stretching the laminate in a second direction (second stretching step). Hereinafter, the respective steps are described.

A-1. First Stretching Step

As a formation material for the resin substrate, any appropriate thermoplastic resin can be adopted. Examples of the thermoplastic resin include: an ester-based resin such as a polyethylene terephthalate-based resin; a cycloolefin-based resin such as a norbornene-based resin; an olefin-based resin such as polypropylene; a polyamide-based resin; a polycarbonate-based resin; and a copolymer resin thereof. Of those, an amorphous (non-crystallized) polyethylene terephthalate-based resin is preferably used. Of those, a noncrystalline (hard-to-crystallize) polyethylene terephthalate-based resin is particularly preferably used. Specific examples of the noncrystalline polyethylene terephthalate-based resin include: a copolymer further containing isophthalic acid as a dicarboxylic acid; and a copolymer further containing cyclohexanedimethanol as a glycol.

In one embodiment, the resin substrate has a percentage of water absorption of preferably 0.2% or more, more preferably 0.3% or more. When an underwater stretching mode is adopted in the stretching to be described later, the resin substrate absorbs water and the water serves as a plasticizer so that the substrate can plasticize. As a result, a stretching stress can be significantly reduced. Accordingly, the stretching can be performed at a high ratio and stretchability can be more excellent than that at the time of aerial stretching. As a result, a polarizing film having excellent optical characteristics can be manufactured. Meanwhile, the percentage of water absorption of the resin substrate is preferably 3.0% or less, more preferably 1.0% or less. The use of such resin substrate can prevent, for example, the following inconvenience. The dimensional stability of the resin substrate remarkably reduces at the time of the manufacture and hence the external appearance of the polarizing film to be obtained deteriorates. In addition, the use can prevent the rupture of the resin substrate at the time of the underwater stretching and the peeling of the PVA-based resin layer from the resin substrate. It should be noted that the percentage of water absorption of the resin substrate can be adjusted by, for example, introducing a modification group into a constituent material. The percentage of water absorption is a value determined in conformity with JIS K 7209.

The glass transition temperature (Tg) of the resin substrate is preferably 170° C. or less. The use of such resin substrate can sufficiently secure the stretchability of the laminate while suppressing the crystallization of the PVA-based resin layer. Further, the glass transition temperature is more preferably 120° C. or less in consideration of the plasticization of the resin substrate by water and favorable performance of the underwater stretching. In one embodiment, the glass transition temperature of the resin substrate is preferably 60° C. or more. The use of such resin substrate prevents an inconvenience such as the deformation of the resin substrate (e.g., the occurrence of unevenness, a slack, or a wrinkle) during the application and drying of an application liquid containing a PVA-based resin to be described later, thereby enabling favorable manufacturing of the laminate. In addition, the use enables the stretching of the PVA-based resin layer to be performed at a suitable temperature (e.g., about 60° C.). In another embodiment, a glass transition temperature lower than 60° C. is permitted as long as the resin substrate does not deform during the application and drying of the application liquid containing the PVA-based resin. It should be noted that the glass transition temperature of the resin substrate can be adjusted by, for example, introducing a modification group into the constituent material or heating the substrate constituted of a crystallization material. The glass transition temperature (Tg) is a value determined in conformity with JIS K 7121.

The thickness of the resin substrate (before the stretching) is preferably from 20 μm to 300 μm, more preferably from 50 μm to 200 μm.

The first direction can be set to any appropriate direction depending on a desired polarizing film. In a preferred embodiment, the first direction is a widthwise direction of a resin substrate having an elongate shape. In this case, there is typically adopted a method involving stretching the resin substrate using a tenter stretching apparatus. In another embodiment, the first direction is a lengthwise direction of a resin substrate having an elongate shape. In this case, there is typically adopted a method involving passing the resin substrate between rolls having different peripheral speeds to stretch the resin substrate.

Any appropriate method can be adopted as a method of stretching the resin substrate. Specifically, fixed-end stretching or free-end stretching may be adopted. The stretching of the resin substrate may be performed in one stage, or may be performed in a plurality of stages. When the stretching is performed in a plurality of stages, the stretching ratio of the resin substrate to be described later is the product of stretching ratios in the respective stages. In addition, a stretching mode in this step is not particularly limited and may be an aerial stretching mode, or may be the underwater stretching mode.

The stretching temperature of the resin substrate can beset to any appropriate value depending on, for example, a formation material for the resin substrate and the stretching mode. The stretching temperature is, with respect to the glass transition temperature (Tg) of the resin substrate, preferably from Tg−10° C. to Tg+80° C. When the polyethylene terephthalate-based resin is used as the formation material for the resin substrate, the stretching temperature is preferably from 70° C. to 150° C., more preferably from 90° C. to 130° C. Performing the stretching at such temperature improves manufacturing efficiency. Specifically, when the stretching temperature is too high, there is a risk in that the effective width of the resin substrate cannot be secured sufficiently because the thickness of a stretching direction end portion of the resin substrate may increase. When the stretching temperature is too low, Δn to be described later may increase, and the effect provided by the heating to be described later may be insufficient.

The stretching ratio of the resin substrate is preferably from 1.5 times to 3.0 times with respect to the original length of the resin substrate. The resin substrate can be used effectively by stretching the resin substrate in the first direction.

The Δn of the resin substrate after the stretching may vary typically depending on the material and stretching conditions for the resin substrate. For example, when the polyethylene terephthalate-based resin is used as the formation material for the resin substrate, the Δn of the resin substrate after the stretching is typically 0.1 or less, preferably 0.01 or less. On the other hand, the Δn of the resin substrate after the stretching is preferably 0.0002 or more. It should be noted that the Δn of the resin substrate in this description is a value calculated by the following equation (1).

Δn=R0/d (1)

R0: A front retardation (nm) of a resin substrate measured at 23° C. with light having a wavelength of 590 nm.

d: A thickness (nm) of the resin substrate.

A-2. Heating Step

After the stretching in the first direction, the resin substrate is heated. Heating of the resin substrate can reduce a residual stress generated in the resin substrate by the stretching in the first direction to decrease a ratio of shrinkage in the first direction in the stretching in the second direction to be described later. As a result, manufacturing efficiency can be improved. Further, the heating decreases the Δn of the resin substrate.

In a preferred embodiment, heating conditions are controlled so that a predetermined Δn may be achieved. When the polyethylene terephthalate-based resin is used as the formation material for the resin substrate, heating is preferably performed so that the Δn of the resin substrate is 0.0016 or less. When the Δn falls within such range, the shrinkage can be favorably suppressed. On the other hand, the Δn of the resin substrate after the heating is preferably 0 or more.

The heating temperature is, with respect to the glass transition temperature (Tg) of the resin substrate, preferably from Tg−10° C. to Tg+80° C., more preferably from Tg° C. to Tg+60° C. Specifically, when the polyethylene terephthalate-based resin is used as the formation material for the resin substrate, the heating temperature is preferably from 70° C. to 150° C., more preferably from 80° C. to 130° C.

The heating time is preferably from 10 seconds to 60 seconds, more preferably from 20 seconds to 40 seconds.

The heating step may be performed continuously or intermittently after the first stretching step, and is preferably performed continuously.

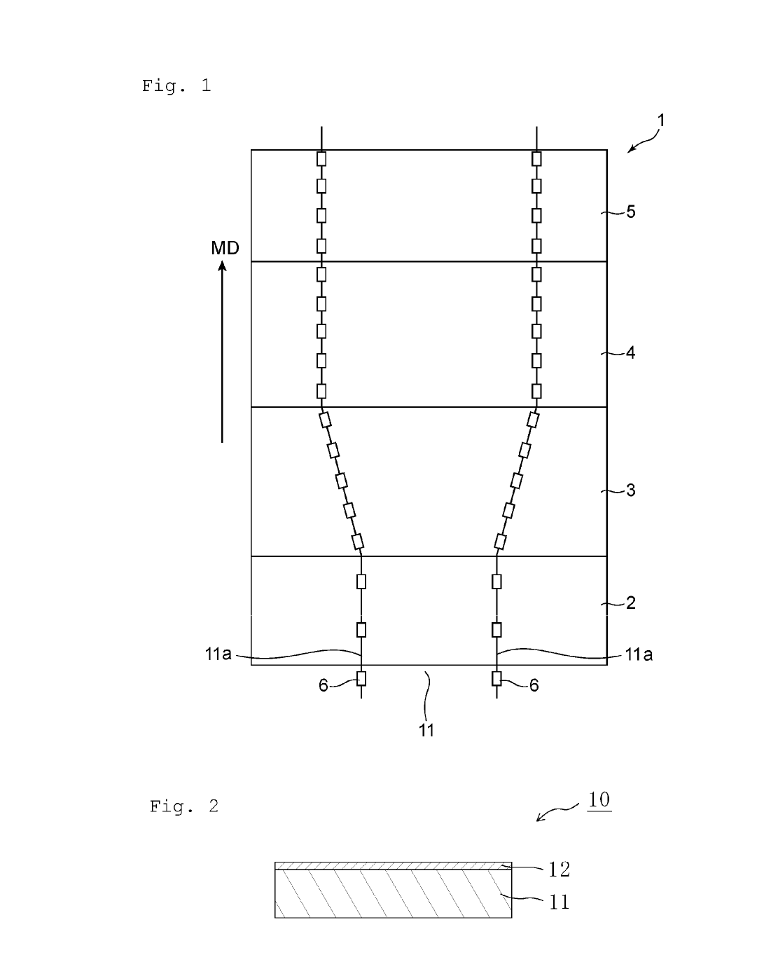

FIG. 1 is a schematic view for illustrating one example of the first stretching step and the heating step. In the illustrated example, a resin substrate 11 having an elongate shape is delivered in its lengthwise direction in a tenter stretching apparatus 1 including, from the entrance side, a preheating zone 2, a first stretching zone 3, a heating zone 4, and a cooling zone 5 in the stated order.

The resin substrate 11 having an elongate shape and rolled into a roll shape is unrolled in advance and widthwise direction end portions 11a and 11a of the resin substrate 11 are held with holding means (clips) 6 and 6. The resin substrate 11 held with the right and left clips 6 and 6 is delivered at a predetermined speed, and introduced to the preheating zone 2, where the resin substrate 11 is heated to the stretching temperature. As means for heating to the stretching temperature, any appropriate means can be adopted. Examples of the means include heating apparatus such as a hot-air heater, a panel heater, and a halogen heater. The hot-air heater is preferably used.

Next, in the first stretching zone 3, the resin substrate 11 is stretched in its widthwise direction at the stretching temperature. Specifically, the clips 6 and 6 holding the end portions 11a and 11a are moved to the outside of the widthwise direction while delivering the resin substrate 11 at a predetermined speed. After the first stretching, the resin substrate 11 is heated continuously to the heating temperature in the heating zone 4. In the heating, the clips 6 and 6 are maintained at a width after the stretching without being substantially moved in the widthwise direction. The term “substantially” as used herein refers to a concept for accepting that, in order to suppress flapping of a film or to finely adjust, for example, the thickness, retardation, and axial direction of the film in the heating step, the clips are moved in a short distance (for example, about 1% of the total width) to reduce the width. As heating means in the heating zone 4, heating means similar to that used in the preheating zone 2 can be adopted. After the heating, the resin substrate 11 is cooled in the cooling zone 5 to a predetermined temperature, and is subjected to the subsequent steps. It should be noted that the respective zones refer to ones in which the resin substrate is substantially preheated, stretched, heated, and cooled, and do not refer to mechanically or structurally independent sections

A-3. Laminate-Producing Step

FIG. 2 is a schematic sectional view of a laminate according to a preferred embodiment of the present invention. A laminate 10 has the resin substrate 11 and a PVA-based resin layer 12, and is produced by forming the PVA-based resin layer 12 on the resin substrate 11. Any appropriate method can be adopted as a method of forming the PVA-based resin layer. The PVA-based resin layer is preferably formed by applying an application liquid containing a PVA-based resin onto the resin substrate and drying the liquid.

Any appropriate resin can be adopted as the PVA-based resin for forming the PVA-based resin layer. Examples of the resin include polyvinyl alcohol and an ethylene-vinyl alcohol copolymer. The polyvinyl alcohol is obtained by saponifying polyvinyl acetate. The ethylene-vinyl alcohol copolymer is obtained by saponifying an ethylene-vinyl acetate copolymer. The saponification degree of the PVA-based resin is typically from 85 mol % to 100 mol %, preferably from 95.0 mol % to 99.95 mol %, more preferably from 99.0 mol % to 99.93 mol %. The saponification degree can be determined in conformity with JIS K 6726-1994. The use of the PVA-based resin having such saponification degree can provide a polarizing film excellent in durability. When the saponification degree is excessively high, the resin may gel.

The average polymerization degree of the PVA-based resin can be appropriately selected depending on purposes. The average polymerization degree is typically from 1,000 to 10,000, preferably from 1,200 to 5,000, more preferably from 1,500 to 4,500. It should be noted that the average polymerization degree can be determined in conformity with JIS K 6726-1994.

The application liquid is typically a solution prepared by dissolving the PVA-based resin in a solvent. Examples of the solvent include water, dimethylsulfoxide, dimethylformamide, dimethylacetamide, N-methylpyrrolidone, various glycols, polyhydric alcohols such as trimethylolpropane, and amines such as ethylenediamine and diethylenetriamine. They may be used alone or in combination. Of those, water is preferred. The concentration of the PVA-based resin of the solution is preferably from 3 parts by weight to 20 parts by weight with respect to 100 parts by weight of the solvent. At such resin concentration, a uniform coating film in close contact with the resin substrate can be formed.

The application liquid may be compounded with an additive. Examples of the additive include a plasticizer and a surfactant. Examples of the plasticizer include polyhydric alcohols such as ethylene glycol and glycerin. Examples of the surfactant include nonionic surfactants. Such additive can be used for the purpose of additionally improving the uniformity, dyeing property, or stretchability of the PVA-based resin layer to be obtained.

Any appropriate method can be adopted as a method of applying the application liquid. Examples of the method include a roll coating method, a spin coating method, a wire bar coating method, a dip coating method, a die coating method, a curtain coating method, a spray coating method, and a knife coating method (comma coating method or the like).

The application liquid is preferably applied and dried at a temperature of 50° C. or more.

The thickness of the PVA-based resin layer (before the stretching) is preferably from 3 μm to 20 μm.

The resin substrate may be subjected to a surface treatment (such as a corona treatment) before the formation of the PVA-based resin layer, or an easy-adhesion layer may be formed on the resin substrate. Such treatment can improve adhesiveness between the resin substrate and the PVA-based resin layer. In addition, any appropriate functional layer (for example, antistatic layer) may be formed on the side of the resin substrate on which the PVA-based resin layer is not formed.

A-4. Second Stretching Step

The second direction can be set to any appropriate direction depending on a desired polarizing film. The second direction is preferably perpendicular to the first direction. For example, when the first direction is the widthwise direction of the resin substrate having an elongate shape, the second direction is preferably the lengthwise direction of the laminate having an elongate shape. It should be noted that the term “perpendicular” as used herein includes a substantially perpendicular angle. The term “substantially perpendicular” as used herein includes an angle of 90°±5.0°, preferably 90°±3.0°, more preferably 90°±1.0°. In addition, the second direction is substantially an absorption axis direction of the polarizing film to be obtained.

Any appropriate method can be adopted as a method of stretching the laminate. Specifically, fixed-end stretching or free-end stretching may be adopted, and the free-end stretching is preferably adopted. The free-end stretching typically means a stretching method involving stretching the laminate in only one direction. When the laminate is stretched in one direction, the laminate may shrink in a direction approximately perpendicular to the stretching direction. A method of stretching the laminate without suppressing the shrinkage is referred to as free-end stretching.

A stretching mode is not particularly limited and may be an aerial stretching mode, or may be an underwater stretching mode. Of those, an underwater stretching mode is preferably adopted. According to the underwater stretching mode, the stretching can be performed at a temperature lower than the glass transition temperature (typically about 80° C.) of each of the resin substrate and the PVA-based resin layer, and hence the PVA-based resin layer can be stretched at a high ratio while its crystallization is suppressed. As a result, a polarizing film having excellent optical characteristics can be manufactured.

The stretching of the laminate may be performed in one stage, or may be performed in a plurality of stages. When the stretching is performed in a plurality of stages, for example, the free-end stretching and fixed-end stretching may be performed in combination, or the underwater stretching mode and the aerial stretching mode may be performed in combination. When the stretching is performed in a plurality of stages, the stretching ratio (maximum stretching ratio) of the laminate to be described later is the product of stretching ratios in the respective stages.

The stretching temperature of the laminate can be set to any appropriate value depending on, for example, the formation material for the resin substrate and the stretching mode. When the aerial stretching mode is adopted, the stretching temperature is preferably equal to or higher than the glass transition temperature (Tg) of the resin substrate, more preferably higher than the glass transition temperature (Tg) of the resin substrate by 10° C. or more, particularly preferably higher than the Tg by 15° C. or more. Meanwhile, the stretching temperature of the laminate is preferably 170° C. or less. Performing the stretching at such temperature suppresses rapid progress of the crystallization of the PVA-based resin, thereby enabling the suppression of an inconvenience due to the crystallization (such as the inhibition of the orientation of the PVA-based resin layer by the stretching).

When the underwater stretching mode is adopted, the liquid temperature of a stretching bath is preferably from 40° C. to 85° C., more preferably from 50° C. to 85° C. At such temperature, the PVA-based resin layer can be stretched at a high ratio while its dissolution is suppressed. Specifically, as described above, the glass transition temperature (Tg) of the resin substrate is preferably 60° C. or more in relation to the formation of the PVA-based resin layer. In this case, when the stretching temperature falls short of 40° C., there is a risk in that the stretching cannot be favorably performed even in consideration of the plasticization of the resin substrate by water. On the other hand, as the temperature of the stretching bath increases, the solubility of the PVA-based resin layer is raised and hence excellent optical characteristics may not be obtained. The immersion time of the laminate in the stretching bath is preferably from 15 seconds to 5 minutes.

When the underwater stretching mode is adopted, the laminate is preferably stretched by being immersed in an aqueous solution of boric acid (boric acid underwater stretching). The use of the aqueous solution of boric acid as the stretching bath can impart, to the PVA-based resin layer, rigidity enough to withstand a tension to be applied at the time of the stretching and such water resistance that the layer does not dissolve in water. Specifically, boric acid can produce a tetrahydroxyborate anion in the aqueous solution to cross-link with the PVA-based resin through a hydrogen bond. As a result, the PVA-based resin layer can be favorably stretched with the aid of the rigidity and the water resistance imparted thereto, and hence a polarizing film having excellent optical characteristics can be manufactured.

The aqueous solution of boric acid is preferably obtained by dissolving boric acid and/or a borate in water as a solvent. The concentration of boric acid is preferably from 1 part by weight to 10 parts by weight with respect to 100 parts by weight of water. Setting the concentration of boric acid to 1 part by weight or more can effectively suppress the dissolution of the PVA-based resin layer, thereby enabling the manufacture of a polarizing film having additionally high characteristics. It should be noted that an aqueous solution obtained by dissolving a boron compound such as borax, glyoxal, glutaric aldehyde, or the like as well as boric acid or the borate in the solvent can also be used.

When the PVA-based resin layer has been caused to adsorb a dichromatic substance (typically iodine) in advance by dyeing to be described later, the stretching bath (aqueous solution of boric acid) is preferably compounded with an iodide. Compounding the bath with the iodide can suppress the elution of iodine that the PVA-based resin layer has been caused to adsorb. Examples of the iodide include potassium iodide, lithium iodide, sodium iodide, zinc iodide, aluminum iodide, lead iodide, copper iodide, barium iodide, calcium iodide, tin iodide, and titanium iodide. Of those, potassium iodide is preferred. The concentration of the iodide is preferably from 0.05 part by weight to 15 parts by weight, more preferably from 0.5 part by weight to 8 parts by weight with respect to 100 parts by weight of water.

The stretching ratio (maximum stretching ratio) of the laminate is preferably 5.0 times or more with respect to the original length of the laminate. Such high stretching ratio can be achieved by adopting, for example, the underwater stretching mode (boric acid underwater stretching). It should be noted that the term “maximum stretching ratio” as used herein refers to a stretching ratio immediately before the rupture of the laminate. The stretching ratio at which the laminate ruptures is separately identified and a value lower than the value by 0.2 is the maximum stretching ratio.

In a preferred embodiment, the laminate is subjected to aerial stretching at a high temperature (e.g., 95° C. or more), and then subjected to the boric acid underwater stretching, and dyeing to be described later. Such aerial stretching is hereinafter referred to as “aerial auxiliary stretching” because the stretching can be regarded as stretching preliminary or auxiliary to the boric acid underwater stretching.

When the aerial auxiliary stretching is combined with the boric acid underwater stretching, the laminate can be stretched at an additionally high ratio in some cases. As a result, a polarizing film having additionally excellent optical characteristics (such as a polarization degree) can be manufactured. For example, when a polyethylene terephthalate-based resin is used as the resin substrate, the resin substrate can be stretched while its orientation is more suppressed, by a combination of the aerial auxiliary stretching and the boric acid underwater stretching than in the case of the boric acid underwater stretching alone. As the orientation property of the resin substrate is raised, its stretching tension increases and hence it becomes difficult to stably stretch the substrate or the resin substrate ruptures. Accordingly, the laminate can be stretched at an additionally high ratio by stretching the resin substrate while suppressing its orientation.

In addition, when the aerial auxiliary stretching is combined with the boric acid underwater stretching, the orientation property of the PVA-based resin is improved and hence the orientation property of the PVA-based resin can be improved even after the boric acid underwater stretching. Specifically, the orientation property of the PVA-based resin is improved in advance by the aerial auxiliary stretching so that the PVA-based resin may easily cross-link with boric acid during the boric acid underwater stretching. Then, the stretching is performed in a state where boric acid serves as a junction, and hence the orientation property of the PVA-based resin is assumed to be high even after the boric acid underwater stretching. As a result, a polarizing film having excellent optical characteristics (such as a polarization degree) can be manufactured.

The stretching ratio in the aerial auxiliary stretching is preferably 3.5 times or less. A stretching temperature in the aerial auxiliary stretching is preferably equal to or higher than the glass transition temperature of the PVA-based resin. The stretching temperature is preferably from 95° C. to 150° C. It should be noted that the maximum stretching ratio when the aerial auxiliary stretching and the boric acid underwater stretching are combined with each other is preferably 5.0 times or more, more preferably 5.5 times or more, still more preferably 6.0 times or more with respect to the original length of the laminate.

A-5. Any Other Step

The manufacturing method for a polarizing film of the present invention may include any other step in addition to the above-mentioned steps. Examples of the other step include a dyeing step, an insolubilizing step, a cross-linking step, a washing step, and a drying step. The other step can be performed at any appropriate timing.

The dyeing step is typically a step of dyeing the PVA-based resin layer with a dichromatic substance. The dyeing step is preferably performed by causing the PVA-based resin layer to adsorb a dichromatic substance. A method for the adsorption is, for example, a method involving immersing the PVA-based resin layer (laminate) in a dyeing liquid containing the dichromatic substance, a method involving applying the dyeing liquid onto the PVA-based resin layer, or a method involving spraying the dyeing liquid on the PVA-based resin layer. Of those, a method involving immersing the laminate in the dyeing liquid containing the dichromatic substance is preferred. This is because the dichromatic substance can favorably adsorb to the layer.

Examples of the dichromatic substance include iodine and a dichromatic dye. Of those, iodine is preferred. The dyeing liquid is an aqueous solution of iodine when iodine is used as the dichromatic substance. The compounding amount of iodine is preferably from 0.1 part by weight to 0.5 part by weight with respect to 100 parts by weight of water. The aqueous solution of iodine is preferably compounded with an iodide so as to increase the solubility of iodine in water. Specific examples of the iodide are as described above. The compounding amount of the iodide is preferably from 0.02 part by weight to 20 parts by weight, more preferably from 0.1 part by weight to 10 parts by weight with respect to 100 parts by weight of water. The liquid temperature of the dyeing liquid at the time of the dyeing is preferably from 20° C. to 50° C. in order that the dissolution of the PVA-based resin may be suppressed. When the PVA-based resin layer is immersed in the dyeing liquid, an immersion time is preferably from 5 seconds to 5 minutes in order that the transmittance of the PVA-based resin layer may be secured. In addition, the dyeing conditions (the concentration, the liquid temperature, and the immersion time) can be set so that the polarization degree or single axis transmittance of the polarizing film to be finally obtained may fall within a predetermined range. In one embodiment, the immersion time is set so that the polarization degree of the polarizing film to be obtained may be 99.98% or more. In another embodiment, the immersion time is set so that the single axis transmittance of the polarizing film to be obtained may be from 40% to 44%.

The insolubilizing step is typically performed by immersing the PVA-based resin layer in an aqueous solution of boric acid. Water resistance can be imparted to the PVA-based resin layer by subjecting the layer to the insolubilizing treatment. The concentration of the aqueous solution of boric acid is preferably from 1 part by weight to 4 parts by weight with respect to 100 parts by weight of water. The liquid temperature of an insolubilizing bath (the aqueous solution of boric acid) is preferably from 20° C. to 50° C.

The cross-linking step is typically performed by immersing the PVA-based resin layer in an aqueous solution of boric acid. Water resistance can be imparted to the PVA-based resin layer by subjecting the layer to the cross-linking treatment. The concentration of the aqueous solution of boric acid is preferably from 1 part by weight to 4 parts by weight with respect to 100 parts by weight of water. In addition, when the cross-linking step is performed after the dyeing step, the solution is preferably further compounded with an iodide. Compounding the solution with the iodide can suppress the elution of iodine that the PVA-based resin layer has been caused to adsorb. The compounding amount of the iodide is preferably from 1 part by weight to 5 parts by weight with respect to 100 parts by weight of water. Specific examples of the iodide are as described above. The liquid temperature of a cross-linking bath (the aqueous solution of boric acid) is preferably from 20° C. to 60° C.

The washing step is typically performed by immersing the PVA-based resin layer in an aqueous solution of potassium iodide. A drying temperature in the drying step is preferably from 30° C. to 100° C.

B. Polarizing Film

A polarizing film of the present invention is substantially a PVA-based resin film that adsorbs and orients a dichromatic substance. The thickness of the polarizing film is preferably 10 μm or less, more preferably 7 μm or less, still more preferably 5 μm or less. Meanwhile, the thickness of the polarizing film is preferably 0.5 μm or more, more preferably 1.5 μm or more. The polarizing film preferably shows absorption dichroism at any wavelength in the wavelength range of from 380 nm to 780 nm. The single axis transmittance of the polarizing film is preferably 40.0% or more, more preferably 41.0% or more, still more preferably 42.0% or more, particularly preferably 42.8% or more. The polarization degree of the polarizing film is preferably 99.8% or more, more preferably 99.9% or more, still more preferably 99.95% or more.

As a method of using the polarizing film, any appropriate method can be adopted. Specifically, the polarizing film may be used in a state of being integrated with the resin substrate or may be transferred from the resin substrate to another member before use.

C. Optical Laminate

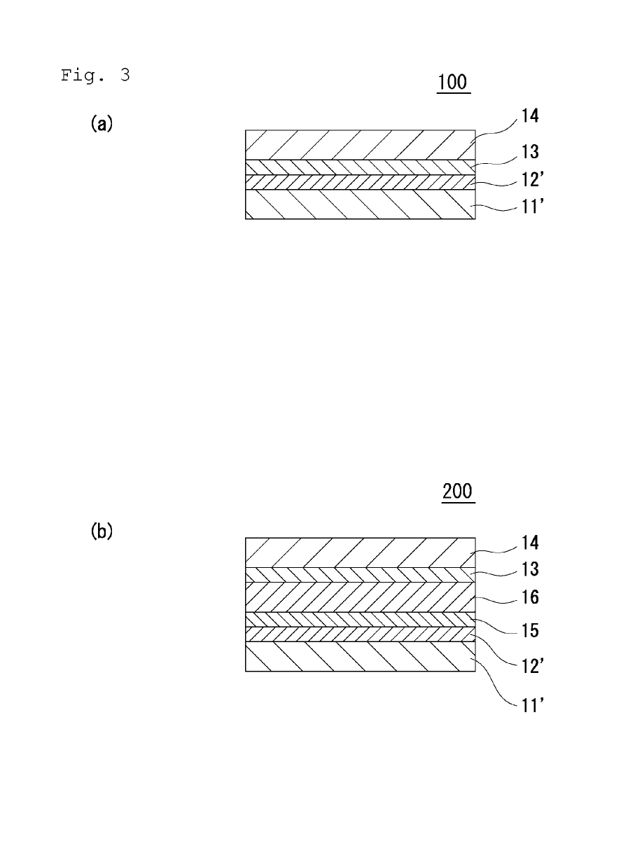

An optical laminate of the present invention includes the polarizing film. FIG. 3(a) and FIG. 3(b) are each a schematic sectional view of an optical film laminate according to a preferred embodiment of the present invention. An optical film laminate 100 includes a resin substrate 11′, a polarizing film 12′, a pressure-sensitive adhesive layer 13, and a separator 14 in the stated order. An optical film laminate 200 includes the resin substrate 11′, the polarizing film 12′, an adhesive layer 15, an optically functional film 16, the pressure-sensitive adhesive layer 13, and the separator 14 in the stated order. In this embodiment, the resin substrate is directly used as an optical member without being peeled from the resultant polarizing film 12′. The resin substrate 11′ can function as, for example, a protective film for the polarizing film 12′.

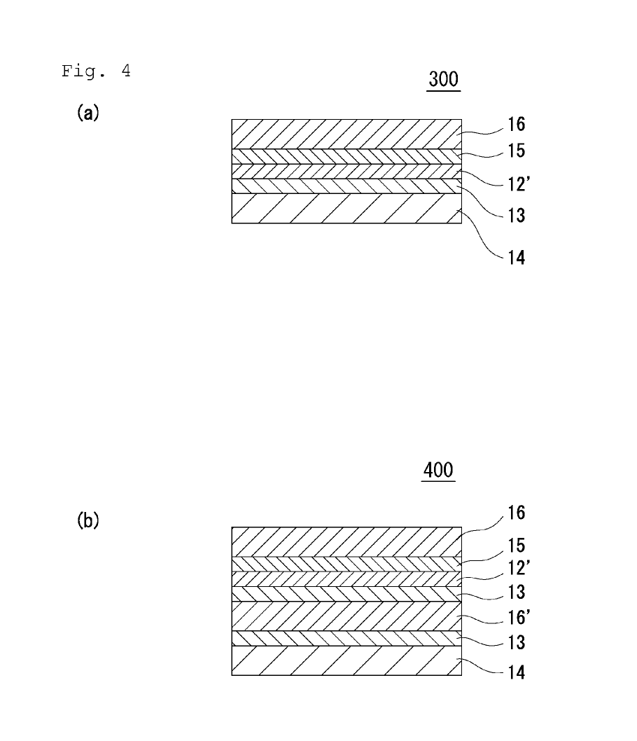

FIG. 4(a) and FIG. 4(b) are each a schematic sectional view of an optically functional film laminate according to another preferred embodiment of the present invention. An optically functional film laminate 300 includes the separator 14, the pressure-sensitive adhesive layer 13, the polarizing film 12′, the adhesive layer 15, and the optically functional film 16 in the stated order. An optically functional film laminate 400 includes, in addition to the construction of the optically functional film laminate 300, a second optically functional film 16′ provided between the polarizing film 12′ and the separator 14 through the pressure-sensitive adhesive layers 13. In this embodiment, the resin substrate has been removed.

The lamination of the respective layers constructing the optical laminate of the present invention is not limited to the illustrated examples, and any appropriate pressure-sensitive adhesive layer or adhesive layer is used. The pressure-sensitive adhesive layer is typically formed of an acrylic pressure-sensitive adhesive. The adhesive layer is typically formed of a vinyl alcohol-based adhesive. The optically functional film can function as, for example, a protective film for a polarizing film or a retardation film.

### EXAMPLES

Hereinafter, the present invention is specifically described by way of Examples. However, the present invention is not limited by these Examples. It should be noted that methods of measuring the respective characteristics are as described below.

### 1. Thickness

Measurement was performed with a digital micrometer (manufactured by Anritsu Corporation, product name: “KC-351C”).

### 2. Glass Transition Temperature (Tg)

Measurement was performed in conformity with JIS K 7121.

### 3. Percentage of Water Absorption

Measurement was performed in conformity with JIS K 7209.

### 4. Front Retardation (R0)

Measurement was performed with Axoscan manufactured by Axometrics, Inc. The measurement wavelength was 590 nm, and the measurement temperature was 23° C.

### Example 1

An amorphous polyethylene terephthalate (A-PET) film (manufactured by Mitsubishi Chemical Corporation, trade name: “NOVACLEAR SHO46,” thickness: 100 μm) having an elongate shape, having a percentage of water absorption of 0.35% and a Tg of 75° C., and containing cyclohexanedimethanol as a copolymerization component was used as a resin substrate. The resin substrate was stretched in its transverse direction at a stretching ratio of 2 times at 105° C. with a tenter stretching apparatus while being delivered in its lengthwise direction. At this time point (after stretching and before heating), the resin substrate had a Δn of 0.00249.

Subsequently, the resin substrate was heated at 120° C. for 30 seconds while being held substantially in its stretching width with clips of the tenter stretching apparatus. After the heating, the resin substrate had a Δn of 0.00124.

Next, an aqueous solution of polyvinyl alcohol having a polymerization degree of 4,200 and a saponification degree of 99.2 mol % was applied onto one surface of the resin substrate and was dried at 60° C. so that a PVA-based resin layer having a thickness of 10 μm was formed, thereby producing a laminate.

The resultant laminate was subjected to free-end uniaxial stretching in its longitudinal direction (lengthwise direction) at 2 times between rolls having different peripheral speeds in an oven at 130° C. (aerial auxiliary stretching).

Next, the laminate was immersed in an insolubilizing bath having a liquid temperature of 30° C. (an aqueous solution of boric acid obtained by compounding 100 parts by weight of water with 4 parts by weight of boric acid) for 30 seconds (insolubilizing step).

Next, the laminate was immersed in a dyeing bath having a liquid temperature of 30° C. (an aqueous solution of iodine obtained by compounding 100 parts by weight of water with 0.2 part by weight of iodine and 1.0 part by weight of potassium iodide) for 60 seconds (dyeing step).

Next, the laminate was immersed in a cross-linking bath having a liquid temperature of 30° C. (an aqueous solution of boric acid obtained by compounding 100 parts by weight of water with 3 parts by weight of potassium iodide and 3 parts by weight of boric acid) for 30 seconds (cross-linking step).

After that, the laminate was uniaxially stretched in its longitudinal direction (lengthwise direction) between rolls having different peripheral speeds while being immersed in an aqueous solution of boric acid having a liquid temperature of 70° C. (an aqueous solution obtained by compounding 100 parts by weight of water with 4 parts by weight of boric acid and 5 parts by weight of potassium iodide) (underwater stretching). In this case, the laminate was stretched immediately before its rupture (the maximum stretching ratio was 6.0 times).

After that, the laminate was immersed in a washing bath having a liquid temperature of 30° C. (an aqueous solution obtained by compounding 100 parts by weight of water with 4 parts by weight of potassium iodide) and was then dried with hot air at 60° C. (washing and drying steps).

Thus, a polarizing film having a thickness of 4.5 μm was formed on the resin substrate.

### Example 2

A polarizing film was formed in the same manner as in Example 1 except that the heating time for the resin substrate was changed to 40 seconds.

### Example 3

A polarizing film was formed in the same manner as in Example 1 except that the heating time for the resin substrate was changed to 50 seconds.

### Example 4

A polarizing film was formed in the same manner as in Example 1 except that the heating temperature and the heating time for the resin substrate were changed to 125° C. and 40 seconds, respectively.

### Example 5

A polarizing film was formed in the same manner as in Example 1 except that the stretching temperature for the resin substrate was changed to 115° C., the heating temperature was changed to 105° C., and the heating time was changed to 40 seconds. In this Example, the resin substrate after the stretching and before the heating had a Δn of 0.00093.

### Comparative Example 1

A polarizing film was formed in the same manner as in Example 1 except that the stretching temperature for the resin substrate was changed to 90° C., and the heating was not performed after the stretching.

### Comparative Example 2

A polarizing film was formed in the same manner as in Example 1 except that the stretching temperature for the resin substrate was changed to 100° C., and the heating was not performed after the stretching.

### Comparative Example 3

A polarizing film was formed in the same manner as in Example 1 except that the heating was not performed after the stretching.

### Comparative Example 4

A polarizing film was formed in the same manner as in Example 5 except that the heating was not performed after the stretching.

### Comparative Example 5

A polarizing film was formed in the same manner as in Example 1 except that the stretching and the heating were not performed for the resin substrate.

For each of Examples and Comparative Examples, a residual width ratio, film thickness distribution, and optical characteristics of the polarizing film were evaluated. Evaluation methods and evaluation criteria are as described below, and the evaluation results are shown in Table 1. It should be noted that Δn in Table 1 represents a value after the heating in each of Examples or a value after the transverse stretching in each of Comparative Example.

### 1. Residual Width Ratio

The residual width ratio was evaluated by measuring the width of the resin substrate after the aerial auxiliary stretching and calculating a residual width ratio with respect to the original length (width) of the resin substrate.

### (Evaluation Criteria)

Good: 120% or more

Bad: less than 120%

### 2. Film Thickness Distribution

The film thickness distribution was evaluated by, after the stretching of the resin substrate, measuring the film thickness at the center part (85%) in the widthwise direction, excluding both the widthwise direction end portions, and calculating a difference between a maximum value and a minimum value.

### (Evaluation Criteria)

Good: less than 10 μm

Bad: 10 μm or more

### 3. Optical Characteristics

The single axis transmittance (Ts), parallel transmittance (Tp), and crossed transmittance (Tc) of the polarizing film were measured with an ultraviolet-visible spectrophotometer (manufactured by JASCO Corporation, product name: “V7100”), and then its polarization degree (P) was determined from the following equation.

Polarization degree (P) (%)={(Tp−Tc)/(Tp+Tc)}^{1/2}×100

It should be noted that the Ts, the Tp, and the Tc are Y values measured with the two-degree field of view (C light source) of JIS Z 8701 and subjected to visibility correction.

### (Evaluation Criteria)

Good: Having a polarization degree of 42.8% or more at a single axis transmittance of 99.99%.

Bad: Having a polarization degree of less than 42.8% at a single axis transmittance of 99.99%.

TABLE 1

| | Transverse stretching | | Heating | | | Residual | Film | Optical |
|---|---|---|---|---|---|---|---|---|
| | Temperature | Stretching ratio | Temperature | Time | | width | thickness | charac- |
| | (° C.) | (times) | (° C.) | (sec) | Δn | ratio | distribution | teristics |
| Example 1 | 105 | 2 | 120 | 30 | 0.00124 | Good | Good | Good |
| Example 2 | 105 | 2 | 120 | 40 | 0.00109 | Good | Good | Good |
| Example 3 | 105 | 2 | 120 | 50 | 0.00082 | Good | Good | Good |
| Example 4 | 105 | 2 | 125 | 40 | 0.00063 | Good | Good | Good |
| Example 5 | 115 | 2 | 105 | 40 | 0.00070 | Good | Good | Good |
| Comparative | 90 | 2 | — | — | 0.00929 | Bad | Good | Good |
| Example 1 | | | | | | | | |
| Comparative | 100 | 2 | — | — | 0.00437 | Bad | Good | Good |
| Example 2 | | | | | | | | |
| Comparative | 105 | 2 | — | — | 0.00249 | Bad | Good | Good |
| Example 3 | | | | | | | | |
| Comparative | 115 | 2 | — | — | 0.00093 | Good | Bad | Good |
| Example 4 | | | | | | | | |
| Comparative | — | — | — | — | 0.00003 | Bad | — | Good |
| Example 5 | | | | | | | | |

In each of Examples, the resin substrate had a high residual width ratio and a highly uniform thickness after the transverse stretching, and was able to sufficiently secure the effective width thereof. On the other hand, in each of Comparative Examples 1, 2, 3, and 5, the resin substrate had a low residual width ratio. In Comparative Example 4, the resin substrate had a large thickness of the widthwise direction end portions after the transverse stretching and was not able to sufficiently secure the effective width thereof.

### INDUSTRIAL APPLICABILITY

The polarizing film of the present invention is suitably used for liquid crystal panels of, for example, liquid crystal televisions, liquid crystal displays, cellular phones, digital cameras, video cameras, portable game machines, car navigation systems, copying machines, printers, facsimile machines, timepieces, and microwave ovens. The polarizing film of the present invention is also suitably used as an antireflection film for an organic EL panel.

1. A manufacturing method for a polarizing film, comprising, in this order, the steps of:
stretching a resin substrate in a first direction;
heating the resin substrate;
forming a polyvinyl alcohol-based resin layer on the resin substrate, to thereby produce a laminate; and
stretching the laminate in a second direction.

2. The manufacturing method according to claim 1, wherein the stretching in the first direction is performed at a temperature of from 70° C. to 150° C.

3. The manufacturing method according to claim 1, wherein the heating is performed at a temperature of from 70° C. to 150° C.

4. The manufacturing method according to claim 1, wherein the resin substrate is formed from a polyethylene terephthalate-based resin.

5. The manufacturing method according to claim 4, wherein the resin substrate after the heating has a Δn of 0.0016 or less.

6. A polarizing film, which is obtained by the manufacturing method of claim 1.

7. An optical laminate, comprising the polarizing film of claim 6.

8. A laminate, comprising:
a resin substrate that is formed from a polyethylene terephthalate-based resin and has a Δn of 0.0016 or less; and
a polyvinyl alcohol-based resin layer formed on the resin substrate.
